(19) United States
(12) Patent Application Publication
(10) Pub. No.: US 2017/0307990 A1
(43) Pub. Date: Oct. 26, 2017

(54) IMAGE BEARING MEMBER FOR ELECTROPHOTOGRAPHY AND METHOD FOR PRODUCING THE SAME

(71) Applicant: Konica Minolta, Inc., Tokyo (JP)

(72) Inventors: Tomoko SAKIMURA, Tokyo (JP); Toyoko SHIBATA, Kanagawa (JP); Masanori YUMITA, Tokyo (JP)

(21) Appl. No.: 15/489,201

(22) Filed: Apr. 17, 2017

(30) Foreign Application Priority Data
Apr. 22, 2016 (JP) 2016-086333

(51) Int. Cl. G03G 5/147; G03G 7/00

(52) U.S. Cl. CPC G03G 5/14734; G03G 5/14795; G03G 7/004; G03G 5/14786; G03G 5/14791; G03G 2215/00957

(57) ABSTRACT

Provided is an image bearing member for electrophotography, the image bearing member being excellent in abrasion resistance, scratch resistance, and toner releasability, and being capable of preventing the occurrence of image defects due to cleaning failure for a long period. The image bearing member for electrophotography according to the present invention includes a surface layer formed of a polymerization-cured product of a radical polymerizable composition. The radical polymerizable composition contains a radical polymerizable perfluoropolyether compound (radical polymerizable PFPE), and the ratio of the average number of fluorine atoms to the average number of radical polymerizable functional groups in the radical polymerizable PFPE is 2.0 to 20.0.

### CROSS REFERENCE TO RELATED APPLICATIONS

This application is entitled to and claims the benefit of Japanese Patent Application No. 2016-086333, filed on Apr. 22, 2016, the disclosure of which including the specification, drawings and abstract is incorporated herein by reference in its entirety.

### BACKGROUND OF THE INVENTION

### 1. Field of the Invention

The present invention relates to an image bearing member for electrophotography, and a method for producing the same.

### 2. Description of Related Art

Recent increase of requirements for images of high resolution and high quality has brought use of a toner with small particle size for an electrophotographic image forming apparatus to the mainstream. A toner with small particle size has high adhesion to the surface of an image bearing member for electrophotography, such as a photoconductor and intermediate transfer member in the image forming apparatus. Thus, the image forming apparatus is likely to suffer from insufficient removal of a remaining toner such as an untransferred residual toner attaching to the surface of the image bearing member. In the case of an image forming apparatus employing a cleaning method with a rubber blade, for example, toner slipping is likely to occur. To prevent such toner slipping, it is required to increase the contact pressure of the rubber blade to the image bearing member. As the contact pressure becomes higher, however, the durability of the image bearing member tends to be lowered because of abrasion of the surface of the image bearing member through repeated use.

To lower the adhesion of an image bearing member to a toner and thereby improve the cleanability, it has been proposed to add a fluorine-containing material such as a fluorine-containing fine particle and a fluorine-containing lubricating agent to the surface layer of an image bearing member. However, increasing such fluorine-containing materials tend to degrade the mechanical properties such as abrasion resistance and scratch resistance of an image bearing member. In addition, the fluorine-containing material is highly surface-oriented and thus tends to be present in the vicinity of the surface of an image bearing member at a high concentration. As a result, the lubricity of such an image bearing member is likely to be lowered to an insufficient level when the surface is worn away through repeated use, although the image bearing member keeps high lubricity in a short period after initiation of use.

As a technique for enhancing both of the abrasion resistance and cleanability of an image bearing member, for example, a surface layer is known which is formed of a polymerization-cured product of a radical polymerizable composition containing a urethane acrylate having a perfluoropolyether site, a trifunctional or higher functional radical polymerizable monomer, and a radical polymerizable compound having a charge-transporting structure (e.g., see Japanese Patent Application Laid-Open No. 2012-128324).

As a technique for maintaining both of the toner releasability and low friction of the surface even after many sheets are printed out, for example, a surface layer is known, the surface layer containing a perfluoropolyether, in which the ratio of the number of fluorine atoms to the number of carbon atoms is 0.10 to 0.40 (e.g., see Japanese Patent Application Laid-Open No. 2015-028613).

However, even the above surface layer containing a perfluoropolyether compound may result in insufficient abrasion resistance in the case that the content of the perfluoropolyether compound is high, and may result in insufficient cleanability after repeated endurance in the case that the content of the perfluoropolyether compound is low. Thus, the above conventional image bearing members still need to be studied from the viewpoint of achieving retention of abrasion resistance and high cleanability in combination.

### SUMMARY OF THE INVENTION

An object of the present invention is to provide an image bearing member for electrophotography, the image bearing member being excellent in abrasion resistance, scratch resistance, and toner releasability, and being capable of preventing the occurrence of image defects due to cleaning failure for a long period.

The present invention provides, as one aspect to solve at least one of the above problems, an image bearing member for electrophotography, the image bearing member including a surface layer, in which the surface layer is formed of a polymerization-cured product of a radical polymerizable composition containing a perfluoropolyether compound having two or more radical polymerizable functional groups, and the ratio of the average number of fluorine atoms to the average number of radical polymerizable functional groups in the perfluoropolyether compound having radical polymerizable functional groups is 2.0 to 20.0.

The perfluoropolyether compound having radical polymerizable functional groups can be composed of a plurality of molecular structures different in the number of radical polymerizable functional groups or the number of repetitions of a fluorine atom-containing site. For example, a compound represented by formula (1) to be described later has two or more radical polymerizable functional groups denoted as B, and has (m+n) units of the fluorine atom-containing sites (CF₂CF₂O) and (CF₂O) in total, where m and n are each an integer of 0 or more. Accordingly, in the present invention, the average values of the number of radical polymerizable functional groups and number of fluorine atoms per molecule of the perfluoropolyether compound having radical polymerizable functional groups are defined as “the average number of radical polymerizable functional groups” and “the average number of fluorine atoms”, respectively.

In addition, the present invention provides, as another aspect to solve at least one of the above problems, a method for producing an image bearing member for electrophotography, the method including: forming a coating film of a coating solution for a surface layer, the coating solution containing a perfluoropolyether compound having two or more radical polymerizable functional groups and a solvent; and drying and curing the coating film to form a surface layer, in which, as the perfluoropolyether compound having radical polymerizable functional groups, a perfluoropolyether compound, which has the ratio of the average number of fluorine atoms to the average number of radical polymerizable functional groups of 2.0 to 20.0, is used.

### BRIEF DESCRIPTION OF DRAWING

The present invention will become more fully understood from the detailed description given hereinbelow and the appended drawing which is given by way of illustration only, and thus is not intended as a definition of the limits of the present invention, and wherein:

FIG. 1 is a schematic illustrating one example of configurations of an image forming apparatus for which an image bearing member according to one embodiment of the present invention is used.

### DESCRIPTION OF THE PREFERRED EMBODIMENTS

Now, one embodiment of the present invention will be described. The image bearing member according to the present embodiment is an image bearing member for electrophotography and includes a surface layer.

An image bearing member for electrophotography refers to an object to bear a latent image or visualized image on its surface in an electrophotographic image forming method.

Examples of such image bearing members include electrophotographic photoconductors and intermediate transfer members (e.g., intermediate transfer belts and intermediate transfer drums).

The surface layer is a layer constituting the surface of the image bearing member, and positioned at the outermost portion in the cross-section of the image bearing member. The thickness of the surface layer may be appropriately determined in accordance with the type of the image bearing member, and is preferably 0.2 to 15 μm, and more preferably 0.5 to 10 μm.

The image bearing member has the same configuration as conventional image bearing members except that the surface layer to be described later is included, and can be produced similarly. The surface layer also has a configuration of any conventional surface layer having features to be described later, and can be formed similarly. For example, the image bearing member as an electrophotographic photoconductor may have the same configuration as an image bearing member described in Japanese Patent Application Laid-Open No. 2012-078620, except the surface layer. In addition, the surface layer may be configured as described in Japanese Patent Application Laid-Open No. 2012-078620 except that the material is different.

Now, the image bearing member will be described in more detail by using an electrophotographic photoconductor as an example.

The electrophotographic photoconductor includes a conductive support, a photosensitive layer disposed on the conductive support, and the above surface layer disposed on the photosensitive layer.

The conductive support is a member being capable of supporting the photosensitive layer and having conductivity. Examples of the conductive support include drums or sheets made of metal; plastic films including a metal foil laminated thereon; plastic films including a film of a conductive material deposited thereon; and metal members, plastic films, or papers including a conductive layer formed by application of a coating material consisting of a conductive material or consisting of a conductive material and a binder resin. Examples of the metal include aluminum, copper, chromium, nickel, zinc, and stainless steel, and examples of the conductive material include the metals, indium oxide, and tin oxide.

The photosensitive layer is a layer for formation of an electrostatic latent image of an intended image on the surface of the image bearing member through light exposure to be described later. The photosensitive layer may be a monolayer, or composed of a plurality of layers laminated. Examples of the photosensitive layer include a monolayer containing a charge transport compound and a charge generation compound, and a laminate of a charge transport layer containing a charge transport compound and a charge generation layer containing a charge generation compound.

The surface layer is a layer disposed on the photosensitive layer and constituting the surface of the image bearing member, and for example, a layer for protection of the photosensitive layer.

The image bearing member may further include any additional component that allows the advantageous effects of the present embodiment to be achieved, in addition to the conductive support and the photosensitive layer. Examples of the additional component include an intermediate layer. The intermediate layer is, for example, a layer which is disposed between the conductive support and the photosensitive layer and has barrier function and adhesive function.

The surface layer is formed of a polymerization-cured product of a radical polymerizable composition containing a perfluoropolyether compound having two or more radical polymerizable functional groups (hereinafter, also referred to as “radical polymerizable PFPE”). In other words, the surface layer is composed of an integrated polymer including a portion formed through radical polymerization of the radical polymerizable functional groups and a perfluoropolyether portion bonding thereto. One or more radical polymerizable PFPEs may be used.

The radical polymerizable PFPE can be represented by formula (1), for example. In the following formula, “A” denotes a divalent or higher valent organic group; “B” denotes a radical polymerizable functional group; and each “1” independently denotes an integer of 1 or more.

[Formula 1]

(B)ₗ-A-CF₂O(CF₂CF₂O)ₘ(CF₂O)ₙCF₂-A-(B)ₗ (1)

The perfluoropolyether portion (hereinafter, also referred to as “PFPE”) in the radical polymerizable PFPE is a portion derived by excluding A and B from the compound represented by formula (1).

The PFPE is an oligomer or polymer including repeating units of perfluoroalkylene ether. Examples of structures of perfluoroalkylene ether repeating units include structures of perfluoromethylene ether repeating units, those of perfluoroethylene ether repeating units, and those of perfluoropropylene ether repeating units. Especially, it is preferred for the perfluoropolyether to include repeating structural unit 1 represented by formula (a) or repeating structural unit 2 represented by formula (b).

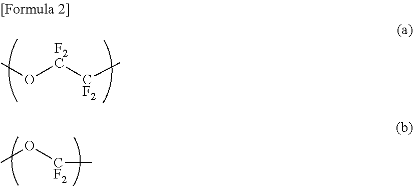

In the case that the PFPE includes repeating structural unit 1 or repeating structural unit 2, the number of repetitions of repeating structural unit 1, m, and the number of repetitions of repeating structural unit 2, n, are, for example, each an integer of 0 or more and satisfy m+n≧1. The m is preferably 2 to 20, and more preferably 4 to 15. The n is preferably 2 to 20, and more preferably 4 to 15.

In the case that the PFPE includes both of repeating structural unit 1 and repeating structural unit 2, repeating structural unit 1 and repeating structural unit 2 may form a block copolymer structure, or a random copolymer structure.

The weight average molecular weight, Mw, of the PFPE is preferably 100 to 8,000, and more preferably 500 to 5,000. The Mw can be determined by using a known method, for example, with gel permeation chromatography (GPC).

The A is a group linking the PFPE and a radical polymerizable functional group, and for example, a divalent or higher valent organic group having an ester bond or urethane bond. The valence of each A is only required to be independently divalent or higher valent.

Each B independently denotes a radical polymerizable functional group. The radical polymerizable functional group is, as that of a radical polymerizable monomer, for example, a group having a carbon-carbon double bond and being radical polymerizable. The radical polymerizable functional group is particularly preferably represented by formula (2), i.e., an acryloyloxy group or methacryloyloxy group (formula (2)). In formula (2), R denotes a hydrogen atom or a methyl group.

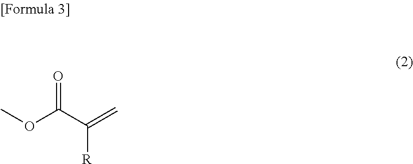

Each 1 independently denotes an integer of 1 or more. Thus, the number of the radical polymerizable functional groups included in the radical polymerizable PFPE is two or more. The configuration in which the number of the radical polymerizable functional groups is two or more provides the surface layer with sufficient film strength. From the viewpoint of facilitating synthesis of the radical polymerizable PFPE, it is preferred for the radical polymerizable PFPE to have a symmetric molecular structure, and from this viewpoint the number of the radical polymerizable functional groups is preferably an even number. Further in view of enhancement of the film strength, the number of the radical polymerizable functional groups is more preferably four or more, and even more preferably six or more.

The radical polymerizable PFPE particularly preferably has a urethane (meth)acrylate structure. The “urethane (meth)acrylate structure” is a structure including an acryloyl group or methacryloyl group as a radical polymerizable functional group and a linking group which includes a urethane bond and links the radical polymerizable functional group to the PFPE. One or more urethane bonds may be present in the urethane (meth)acrylate structure, and the urethane (meth)acrylate structure may further include any additional structure that allows the advantageous effects of the present embodiment to be achieved, such as a polyol portion and a linear hydrocarbon portion.

In the present specification, each of “(meth)acrylate”, “(meth)acrylic acid”, and “(meth)acryloyl” is a collective term for corresponding acrylic and methacrylic substances, and means one or both of them.

The ratio of the average number of fluorine atoms, F_{N}, to the average number of radical polymerizable functional groups RP_{N}, F_{N}/RP_{N}, in the radical polymerizable PFPE is 2.0 to 20.0. Excessively low F_{N}/RP_{N} may result in insufficient toner releasability to cause image defects due to cleaning failure. Excessively high F_{N}/RP_{N} can provide satisfactory toner releasability, but may result in formation of a surface layer having insufficient mechanical strength, leading to insufficient abrasion resistance and scratch resistance. From the viewpoint of ensuring sufficient toner releasability, the F_{N}/RP_{N} is preferably 5 or higher. From the viewpoint of ensuring sufficient abrasion resistance and scratch resistance, the F_{N}/RP_{N} is preferably 15 or lower.

The F_{N}/RP_{N} can be determined by using a known method to specify the quantitative ratio between specific two types of substituents in a compound. For example, the F_{N}/RP_{N} can be determined from integrated values of specific chemical shifts in ¹H-nuclear magnetic resonance (NMR) and ¹⁹F-NMR for the radical polymerizable PFPE. Specifically, the F_{N} can be determined from a ratio between an integrated value for fluorine atoms bonding to a carbon adjacent to the organic group, A, and an integrated value for the other fluorine atoms derived from the PFPE, in ¹⁹F-NMR for the radical polymerizable PFPE. The RP_{N} can be determined from a value converted from a ratio between an integrated value of the chemical shift of hydrogen atoms bonding to carbon atoms forming a carbon-carbon double bond in radical polymerizable functional groups and an integrated value of the chemical shift of methylene groups each adjacent to an end of the PFPE chain.

The radical polymerizable PFPE can be obtained through synthesis by using a known method. Specifically, a PFPE compound having a hydroxy group or carboxyl group at an end is used as a raw material, and the radical polymerizable PFPE can be appropriately synthesized by substitution of or derivatization from the substituent. Examples of such methods for synthesizing the radical polymerizable PFPE include the following methods.

1) A method of esterifying a PFPE compound having a hydroxy group at an end with (meth)acryloyl chloride through dehydrochlorination.

2) A method of urethanizing a PFPE compound having a hydroxy group at an end with an isocyanate compound having a (meth)acryloyl group.

3) A method of converting a PFPE compound having a carboxyl group at an end into an acid halide by using a conventional method and then esterifying the acid halide with a compound having a (meth)acryloyl group and a hydroxy group.

Examples of PFPE compounds having a hydroxy group at an end include Fomblin D2, Fluorolink D4000, Fluorolink E10H, 5158X, 5147X, and Fomblin Z-tet-raol manufactured by Solvay Specialty Polymers, and Demnum-SA manufactured by DAIKIN INDUSTRIES, LTD. Examples of PFPE compounds having a carboxyl group at an end include Fomblin ZDIZAC4000 manufactured by Solvay Specialty Polymers and Demnum-SH manufactured by DAIKIN INDUSTRIES, LTD. “FOMBLIN” is a registered trademark possessed by Solvay Specialty Polymers. “DEMNUM” is a registered trademark possessed by DAIKIN INDUSTRIES, LTD.

Examples of the radical polymerizable PFPE include compounds represented by formulas PFPE-1 to PFPE-12. In the following formulas, each X independently denotes an acryloyl group or a methacryloyl group, m and n are the same as those in formula (1), and each p independently denotes an integer of 1 to 10.

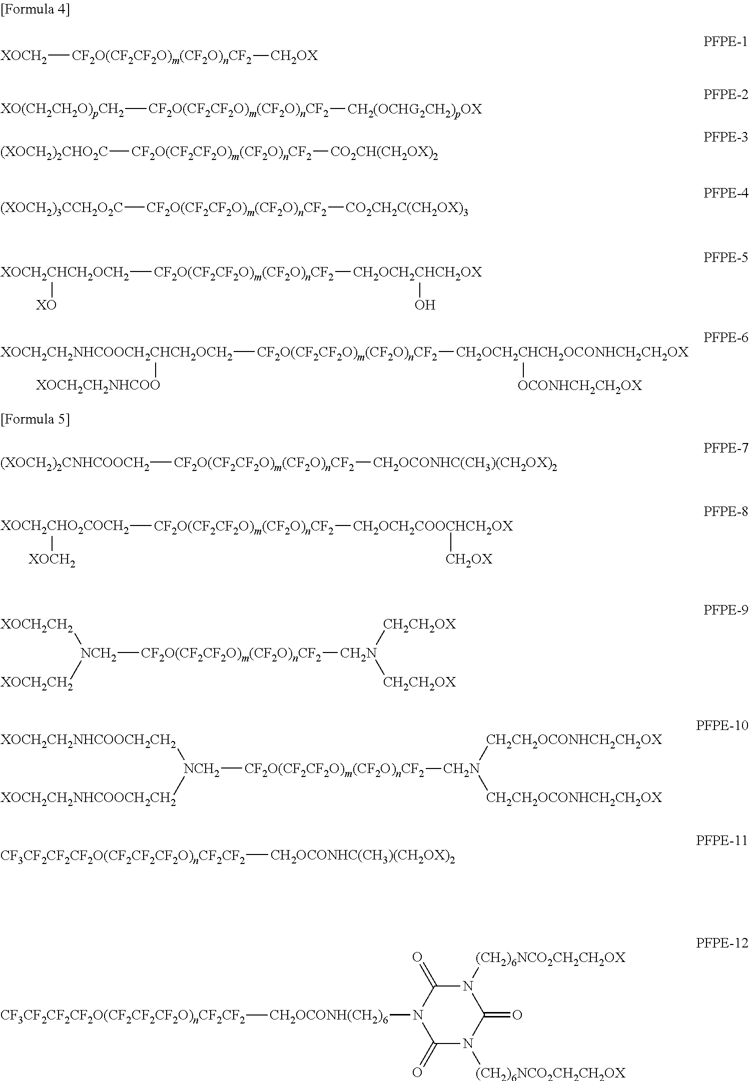

Further, preferred examples of the radical polymerizable PFPE include a compound having PFPE and hydrocarbon groups having a plurality of branched radical polymerizable functional groups bonding to one end or both ends of the PFPE (hereinafter, also referred to as “PFPE-X”). The PFPE-X can be obtained, for example, as follows: a first radical polymerizable compound (also referred to as “compound (A)”) having a perfluoropolyether chain and a radical polymerizable functional group at each end of the perfluoropolyether chain and a second radical polymerizable compound (also referred to as “radical polymerizable compound (B)”) having first reactive functional group (b) are copolymerized to generate polymer (P); and first reactive functional group (b) of polymer (P) thus obtained is reacted with a third radical polymerizable compound (also referred to as “compound (C)”) having second reactive functional group (c), which is reactive with first reactive functional group (b), and a radical polymerizable functional group.

Examples of compound (A) include compounds represented by formulas A-1 to A-4.

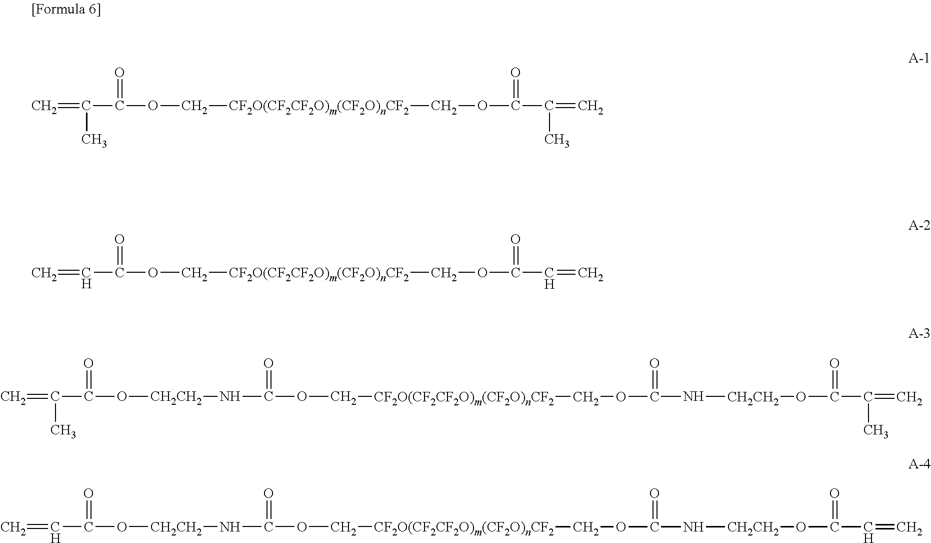

Compound (A) can be synthesized by using a known method such as a method of subjecting a perfluoropolyether compound having one hydroxy group at each end to dehydrochlorination reaction with (meth)acryloyl chloride, a method of subjecting (meth)acrylic acid to dehydration reaction, and a method of urethanizing 2-(meth)acryloyloxyethyl isocyanate.

First reactive functional group (b) in radical polymerizable compound (B) may be any functional group which is not consumed in radical polymerization of compound (A) and radical polymerizable compound (B). Examples of first reactive functional group (b) include a hydroxy group, an isocyanate group, an epoxy group, and a carboxyl group.

Examples of radical polymerizable compound (B) include hydroxy group-containing unsaturated monomers, isocyanate group-containing unsaturated monomers, epoxy group-containing unsaturated monomers, carboxyl group-containing unsaturated monomers, and acid anhydrides.

Examples of the hydroxy group-containing unsaturated monomer include 2-hydroxyethyl (meth)acrylate, 2-hydroxypropyl (meth)acrylate, 3-hydroxypropyl (meth)acrylate, 2-hydroxybutyl (meth)acrylate, 4-hydroxybutyl (meth)acrylate, 1,4-cyclohexanedimethanol mono(meth)acrylate, N-(2-hydroxyethyl)(meth)acrylamide, glycerin mono(meth)acrylate, polyethylene glycol mono(meth)acrylate, polypropylene glycol mono(meth)acrylate, 2-hydroxy-3-phenoxypropyl (meth)acrylate, 2-(meth)acryloyloxyethyl-2-hydroxyethyl phthalate, and end hydroxy group-containing lactone-modified (meth)acrylate.

Examples of the isocyanate group-containing unsaturated monomer include 2-(meth)acryloyloxyethyl isocyanate, 2-(2-(meth)acryloyloxyethoxy)ethyl isocyanate, and 1,1-bis((meth)acryloyloxymethyl)ethyl isocyanate.

Examples of the epoxy group-containing unsaturated monomer include glycidyl methacrylate and 4-hydroxybutyl acrylate glycidyl ether.

Examples of the carboxyl group-containing unsaturated monomer include (meth)acrylic acid, 2-(meth)acryloyloxyethyl succinate, 2-(meth)acryloyloxyethyl phthalate, maleic acid, and itaconic acid.

Examples of the acid anhydride include maleic anhydride and itaconic anhydride.

Examples of methods for producing polymer (P) include, as described above, a method of polymerizing compound (A) and radical polymerizable compound (B), and in addition another radical polymerizable unsaturated monomer, as necessary, with a radical polymerization initiator in an organic solvent.

One or more radical polymerization initiators may be used. The radical polymerization initiator can be appropriately chosen from known polymerization initiators in accordance with a production process for the surface layer. Examples of radical polymerization initiators include photopolymerization initiators, thermal polymerization initiators, and polymerization initiators capable of initiating polymerization by both light and heat.

Examples of the radical polymerization initiator include azo compounds such as 2,2′-azobisisobutyronitrile, 2,2′-azobis(2,4-dimethylazobisvaleronitrile), and 2,2′-azobis(2-methylbutyronitrile); and peroxides such as benzoyl peroxide (BPO), di-tert-butyl hydroperoxide, tert-butyl hydroperoxide, chlorobenzoyl peroxide, dichlorobenzoyl peroxide, bromomethylbenzoyl peroxide, and lauroyl peroxide.

Examples of the radical polymerization initiator further include acetophenone-based or ketal photopolymerization initiators, and examples thereof include diethoxyacetophenone, 2,2-dimethoxy-1,2-diphenylethan-1-one, 1-hydroxycyclohexylphenyl ketone, 4-(2-hydroxyethoxy)phenyl-(2-hydroxy-2-propyl) ketone, 2-benzyl-2-dimethylamino-1-(4-morpholinophenyl)butanone-1 (IRGACURE 369: manufactured by BASF Japan Ltd., “IRGACURE” is a registered trademark possessed by BASF SE), 2-hydroxy-2-methyl-1-phenylpropan-1-one, 2-methyl-2-morpholino(4-methylthiophenyl)propan-1-one, and 1-phenyl-1,2-propanedione-2-(o-ethoxycarbonyl)oxime.

Examples of the radical polymerization initiator further include benzoin ether photopolymerization initiators such as benzoin, benzoin methyl ether, benzoin ethyl ether, benzoin isobutyl ether, and benzoin isopropyl ether, and benzophenone-based photopolymerization initiators such as benzophenone, 4-hydroxybenzophenone, methyl o-benzoylbenzoate, 2-benzoylnaphthalene, 4-benzoylbiphenyl, 4-benzoylphenyl ether, acrylated benzophenone, and 1,4-benzoylbenzene.

Examples of the radical polymerization initiator further include thioxanthone-based photopolymerization initiators such as 2-isopropylthioxanthone, 2-chlorothioxanthone, 2,4-dimethylthioxanthone, 2,4-diethylthioxanthone, and 2,4-dichlorothioxanthone.

Examples of the radical polymerization initiator further include ethylanthraquinone, 2,4,6-trimethylbenzoyldiphenylphosphine oxide, 2,4,6-trimethylbenzoylphenylethoxyphosphine oxide, bis(2,4,6-trimethylbenzoyl)phenylphosphineoxide, bis(2,4-dimethoxybenzoyl)-2,4,4-trimethylpentylphosphine oxide, methylphenyl glyoxylate, 9,10-phenanthrene, acridine-based compounds, triazine-based compounds, and imidazole-based compounds.

A photopolymerization accelerator having photopolymerization-accelerating effect may be used in combination with the photopolymerization initiator. Examples of the photopolymerization accelerator include triethanolamine, methyldiethanolamine, ethyl 4-dimethylaminobenzoate, isoamyl 4-dimethylaminobenzoate, (2-dimethylamino)ethyl benzoate, and 4,4′-dimethylaminobenzophenone.

The radical polymerization initiator is preferably a photopolymerization initiator, for example, an alkylphenone compound or a phosphine oxide compound, and more preferably a polymerization initiator having an α-hydroxyacetophenone structure or a polymerization initiator having an acylphosphine oxide structure.

In production of polymer (P), a chain transfer agent may be used in combination with the radical polymerization initiator, as necessary. Examples of the chain transfer agent include lauryl mercaptan, 2-mercaptoethanol, thioglycerol, ethyl thioglycolate, and octyl thioglycolate.

For the molecular weight of polymer (P), any molecular weight such that insolubilization due to crosslinking is not caused during polymerization can be appropriately chosen. If the molecular weight is excessively high, insolubilization of a polymerization product due to crosslinking may be caused. From the viewpoint of prevention of such insolubilization and increase of the number of radical polymerizable functional groups per molecule of the PFPE-X to be finally obtained, the molecular weight of polymer (P) is preferably 800 to 3,000, particular preferably 1,000 to 2,500 in terms of number average molecular weight (Mn), or preferably 1,500 to 40,000, particularly preferably 2,000 to 30,000 in terms of weight average molecular weight (Mw).

Polymer (P) is further reacted with compound (C) having second reactive functional group (c) and a radical polymerizable functional group, as described above, and thus the PFPE-X intended can be obtained.

Examples of second reactive functional group (c) include a hydroxy group, an isocyanate group, an epoxy group, a carboxyl group, and a carboxylic acid halide group. In the case that first reactive functional group (b) is a hydroxy group, more specifically, examples of second reactive functional group (c) include an isocyanate group, a carboxyl group, a carboxylic acid halide group, and an epoxy group. In the case that first reactive functional group (b) is an isocyanate group, examples of second reactive functional group (c) include a hydroxy group. In the case that first reactive functional group (b) is an epoxy group, examples of second reactive functional group (c) include a carboxyl group and a hydroxy group. In the case that first reactive functional group (b) is a carboxyl group, examples of second reactive functional group (c) include an epoxy group and a hydroxy group.

Specific examples of compound (C) include, in addition to the compounds exemplified for radical polymerizable compound (B), 2-hydroxy-3-acryloyloxypropyl methacrylate, pentaerythritol triacrylate, and dipentaerythritol pentaacrylate.

To react polymer (P) with compound (C), reaction is suitably performed under conditions such that the second reactive functional group of compound (C) reacts with the first radical polymerizable functional group of polymer (P) and the radical polymerizable functional group of compound (C) does not undergo radical polymerization. For example, the reaction is preferably performed at 30 to 120° C. The reaction can be performed in the presence of a catalyst, a polymerization inhibitor, or the like, and can be performed in the presence of an organic solvent, as necessary.

The molecular weight of the PFPE-X is preferably 1,000 to 5,000, and more preferably 1,500 to 4,000 in terms of number average molecular weight (Mn). In terms of weight average molecular weight (Mw), the molecular weight is preferably 3,000 to 50,000, and more preferably 4,000 to 40,000.

The content of the radical polymerizable PFPE in the radical polymerizable composition may be any value that is 100mass % or less. However, the cleanability of the image bearing member tends to be lowered if the content is low, and the abrasion resistance and scratch resistance tend to be lowered if the content is excessively high, although such lowering depends on the F_{N}/RP_{N}. From the viewpoint of the cleanability, the content is preferably 5mass % or more, more preferably 8mass % or more, and even more preferably 10mass % or more, relative to the total solid content of the radical polymerizable composition. From the viewpoint of enhancement of the abrasion resistance and scratch resistance, the content is preferably 80mass % or less, more preferably 60mass % or less, and even more preferably 50mass % or less.

The ratio of the number of fluorine atoms, F, to the number of carbon atoms, C, F/C, in the surface of the surface layer of the image bearing member indicates the amount of PFPE present in the surface layer, and excessively small F/C may impart insufficient cleanability to the image bearing member, and excessively large F/C may impart insufficient abrasion resistance and scratch resistance to the image bearing member. From the viewpoint of sufficiently ensuring the cleanability, abrasion resistance, and scratch resistance of the image bearing member, the F/C is preferably 0.30 to 1.60. This means that a sufficient amount of PFPE is present in the surface layer. The F/C can be measured by using electron spectroscopy for chemical analysis (ESCA).

The radical polymerizable composition may further contain any additional component that allows the advantageous effects of the present embodiment to be achieved, in addition to the radical polymerizable PFPE. Examples of the additional component include radical polymerizable monomers, metal oxide fine particles having a radical polymerizable functional group, solvents, and the above radical polymerization initiators.

The radical polymerizable monomer is a compound which has a radical polymerizable functional group, and undergoes radical polymerization (curing) when being irradiated with an actinic ray such as an ultraviolet ray, a visible ray, and an electron beam, or when being provided with energy by heating or the like, and is thus converted to a resin to be typically used as a binder resin for an image bearing member. Examples of radical polymerizable monomers include styrenic monomer, acrylic monomer, methacrylic monomer, vinyltoluene monomer, vinyl acetate monomer, and N-vinylpyrrolidone monomer, and examples of the binder resin include polystyrene and polyacrylate.

The radical polymerizable functional group is, for example, a group having a carbon-carbon double bond and being radical polymerizable. The radical polymerizable functional group is particularly preferably an acryloyl group (CH₂═CHCO—) or a methacryloyl group (CH₂═C(CH₃)CO—) because such groups can be cured with a small amount of light or in a short time.

Examples of the radical polymerizable monomer include compounds M1 to M11. In the following formulas, R denotes an acryloyl group, and R′ denotes a methacryloyl group.

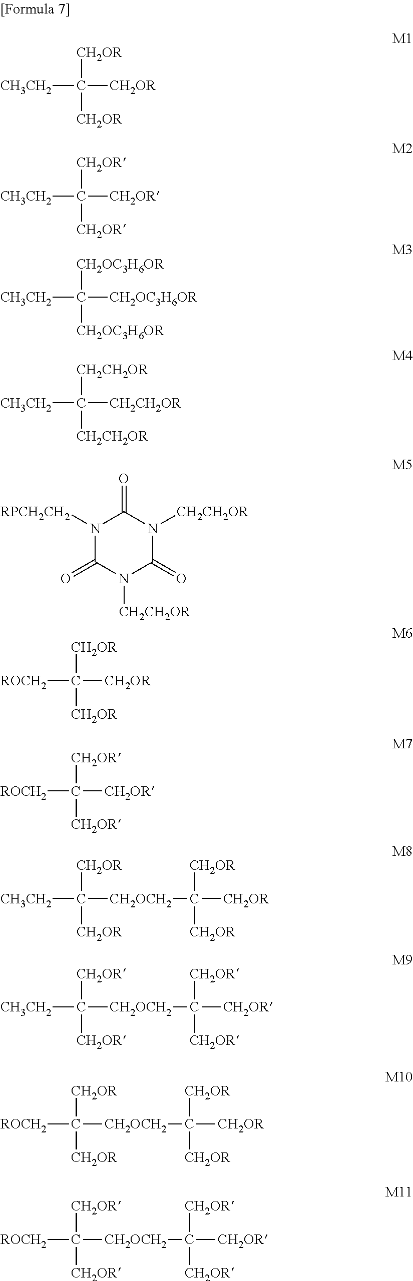

Each of the radical polymerizable monomers is known, and available as a commercial product. The radical polymerizable monomer is preferably a compound having three or more radical polymerizable functional groups, from the viewpoint of formation of a surface layer having high crosslinking density and thus having high hardness.

The content of the radical polymerizable monomer in the radical polymerizable composition is preferably 5mass % or more and 80mass % or less, more preferably 10mass % or more and 70mass % or less, and even more preferably 20mass % or more and 60mass % or less, relative to the total solid content of the radical polymerizable composition.

The surface layer is preferably a polymerization-cured product of the radical polymerizable composition further containing a metal oxide fine particle having the radical polymerizable functional group (hereinafter, also referred to as “radical polymerizable metal oxide fine particle”), from the viewpoint of further increase of the hardness of the surface layer.

The radical polymerizable metal oxide fine particle is a metal oxide fine particle supporting a component containing the radical polymerizable functional group on the surface. Supporting of a component containing the radical polymerizable functional group on the surface of the metal oxide fine particle may be physical supporting, or may be achieved by chemical bonding. One or more types of the radical polymerizable functional groups may be present, and they may be identical or different.

The radical polymerizable metal oxide fine particle includes, for example, a metal oxide fine particle, a surface treating agent residue chemically bonding to the surface of the metal oxide fine particle, and the radical polymerizable functional group included in the surface treating agent residue, and the metal oxide fine particle is present in the surface layer in a state in which the metal oxide fine particle is chemically bonding to an integrated polymer constituting the surface layer via the surface treating agent residue present on the surface of the metal oxide fine particle. Here, the surface treating agent residue is, for example, a molecular structure chemically bonding to the surface of the metal oxide fine particle and is a portion derived from a surface treating agent.

From the above viewpoint, the content of the radical polymerizable metal oxide fine particle in the radical polymerizable composition is 5mass % or more and 80mass % or less, more preferably 10mass % or more and 70mass % or less, and even more preferably 20mass % or more and 60mass % or less, relative to the total solid content of the radical polymerizable composition.

Examples of the metal in the metal oxide fine particle even include transition metals. Further, one or more types of metal oxide fine particles may be used, and they may be identical or different. Examples of metal oxides for the metal oxide fine particle include silica (silicon oxide), magnesium oxide, zinc oxide, lead oxide, alumina (aluminum oxide), tin oxide, tantalum oxide, indium oxide, bismuth oxide, yttrium oxide, cobalt oxide, copper oxide, manganese oxide, selenium oxide, iron oxide, zirconium oxide, germanium oxide, tin oxide, titanium dioxide, niobium oxide, molybdenum oxide, vanadium oxide, and copper-aluminum oxide. Among them, alumina (Al₂O₃), tin oxide (SnO₂), titanium dioxide (TiO₂), and copper-aluminum composite oxide (CuAlO₂) are preferred.

The number average primary particle size of the metal oxide fine particle is preferably 1 nm or larger and 300 nm or smaller, and particularly preferably 3 nm or larger and 100 nm or smaller. The number average primary particle size of the metal oxide fine particle may be a catalog value, or otherwise can be determined as follows. Specifically, an enlarged photograph taken with a scanning electron microscope (manufactured by JEOL Ltd.) at a magnification of 10,000× is fed to a scanner, and 300 particle images randomly selected from the resulting photograph image, with images of agglomerated particles excluded, are binarized by using the automated image processing/analysis system “LUZEX AP” (manufactured by NIRECO CORPORATION, “LUZEX” is a registered trademark possessed by the company, software Ver.1.32) to calculate the horizontal Feret's diameter of each particle image, and the average value is calculated as the number average primary particle size. Here, the horizontal Feret's diameter refers to the length of the side parallel to the x axis in a rectangle circumscribing the binarized particle image.

Supporting of the component containing the radical polymerizable functional group on the surface of the metal oxide fine particle can be achieved by using a known surface treatment technique for metal oxide fine particles. For example, such supporting can be achieved by using a known surface treatment technique with a surface treating agent for metal oxide fine particles, as described in Japanese Patent Application Laid-Open No. 2012-078620.

The surface treating agent has a radical polymerizable functional group and a surface treating group. One or more surface treating agents may be used. The surface treating group is a functional group reactive with a polar group, such as a hydroxy group, present on the surface of the metal oxide fine particle. The radical polymerizable functional group is, as that of the radical polymerizable monomer or the radical polymerizable PFPE, for example, a group having a carbon-carbon double bond and being radical polymerizable, and examples thereof include a vinyl group, an acryloyl(oxy) group, and a methacryloyl(oxy) group.

The surface treating agent is preferably a silane coupling agent having such a radical polymerizable functional group, and examples thereof include compounds S-1 to S-31.

S-1: CH₂═CHSi(CH₃)(OCH₃)₂

S-2: CH₂═CHSi(OCH₃)₃

S-3: CH₂═CHSiCl₃

S-4: CH₂═CHCOO(CH₂)₂Si(CH₃)(OCH₃)₂

S-5: CH₂═CHCOO(CH₂)₂Si(OCH₃)₃

S-6: CH₂═CHCOO(CH₂)₂Si(OC₂H₅)(OCH₃)₂

S-7: CH₂═CHCOO(CH₂)₃Si(OCH₃)₃

S-8: CH₂═CHCOO(CH₂)₂Si(CH₃)Cl₂

S-9: CH₂═CHCOO(CH₂)₂SiCl₃

S-10: CH₂═CHCOO(CH₂)₃Si(CH₃)Cl₂

S-11: CH₂═CHCOO(CH₂)₃SiCl₃

S-12: CH₂═C(CH₃)COO(CH₂)₂Si(CH₃)(OCH₃)₂

S-13: CH₂═C(CH₃)COO(CH₂)₂Si(OCH₃)₃

S-14: CH₂═C(CH₃)COO(CH₂)₃Si(CH₃)(OCH₃)₂

S-15: CH₂═C(CH₃)COO(CH₂)₃Si(OCH₃)₃

S-16: CH₂═C(CH₃)COO(CH₂)₂Si(CH₃)Cl₂

S-17: CH₂═C(CH₃)COO(CH₂)₂SiCl₃

S-18: CH₂═C(CH₃)COO(CH₂)₃Si(CH₃)Cl₂

S-19: CH₂═C(CH₃)COO(CH₂)₃SiCl₃

S-20: CH₂═CHSi(C₂H₅)(OCH₃)₂

S-21: CH₂═C(CH₃)Si(OCH₃)₃

S-22: CH₂═C(CH₃)Si(OC₂H₅)₃

S-23: CH₂═CHSi(OC₂H₅)₃

S-24: CH₂═C(CH₃)Si(CH₃)(OCH₃)₂

S-25: CH₂═CHSi(CH₃)Cl₂

S-26: CH₂═CHCOOSi(OCH₃)₃

S-27: CH₂═CHCOOSi(OC₂H₅)₃

S-28: CH₂═C(CH₃)COOSi(OCH₃)₃

S-29: CH₂═C(CH₃)COOSi(OC₂H₅)₃

S-30: CH₂═C(CH₃)COO(CH₂)₃Si(OC₂H₅)₃

S-31: CH₂═CHCOO(CH₂)₂Si(CH₃)₂(OCH₃)

The image bearing member can be produced by using a method including: forming a coating film of a coating solution for a surface layer, the coating solution containing the radical polymerizable PFPE and a solvent; and drying and curing (causing radical polymerization by irradiation with an actinic ray such as an ultraviolet ray and an electron beam) the coating film to form the surface layer. The coating solution for a surface layer can be composed of the above-described radical polymerizable composition itself.

As described above, the PFPE-X among the radical polymerizable PFPEs can be produced by using a method including: copolymerizing, through radical polymerization, a first radical polymerizable compound having the PFPE and a radical polymerizable functional group at each end of the PFPE and a second radical polymerizable compound having a first reactive functional group; and reacting the first reactive functional group of the copolymer obtained through the copolymerizing with a second reactive functional group of a third radical polymerizable compound having the second reactive functional group and a radical polymerizable functional group, the second reactive functional group being reactive with the first reactive functional group. The method for producing the image bearing member may further include the method for producing PFPE-X.

One or more solvents may be used. Examples of the solvent include methanol, ethanol, n-propyl alcohol, isopropyl alcohol, n-butanol, t-butanol, sec-butanol, benzyl alcohol, toluene, xylene, methyl ethyl ketone, cyclohexane, ethyl acetate, butyl acetate, methylcellosolve, ethylcellosolve, tetrahydrofuran, 1,3-dioxane, 1,3-dioxolane, pyridine, and diethylamine.

The content of the radical polymerization initiator in the radical polymerizable composition is preferably 0.1 parts by weight or more and 40 parts by weight or less, and more preferably 0.5 parts by weight or more and 20 parts by weight or less, relative to 100 parts by weight of the radical polymerizable components (e.g., the total quantity of the radical polymerizable PFPE and the radical polymerizable monomer).

The image bearing member can be produced by using a known method for producing an image bearing member, except that the coating material for a surface layer (the radical polymerizable composition) is used. For example, the image bearing member as an electrophotographic photoconductor can be produced by using a method including: applying a coating solution for a surface layer, the coating solution containing the radical polymerizable composition, onto the surface of a photosensitive layer formed on a conductive support; and irradiating the applied coating solution for a surface layer with an actinic ray or heating the applied coating solution for a surface layer to allow the radical polymerizable functional group in the coating solution for a surface layer to undergo radical polymerization.

In the surface layer, the radical polymerizable PFPE (and the radical polymerizable monomer, and the radical polymerizable metal oxide fine particle) constitutes an integrated polymer (polymerization-cured product) constituting the surface layer. Analysis of the polymerization-cured product by using a known instrumental analysis technique such as pyrolysis GC-MS, nuclear magnetic resonance (NMR), a Fourier transform infrared spectrometer (FT-IR), and elemental analysis can confirm that the polymerization-cured product is a polymer of the radical polymerizable compound.

To keep the cleanability of an image bearing member high even after repeated use, it is necessary in general that a perfluoropolyether portion be present in a sufficient quantity in the surface layer. Generally, the perfluoropolyether portion has low compatibility with the other compounds as raw materials of the surface layer, and cissing is likely to occur in formation of a coating film if a larger quantity of the perfluoropolyether is added to keep the cleanability high. To avoid cissing, it is necessary to use a dispersant in combination with the radical polymerizable composition. However, addition of a dispersant is likely to lower the abrasion resistance or scratch resistance.

The radical polymerizable PFPE has high compatibility with the other compounds as raw materials of the surface layer because the ratio of the number of fluorine atoms to the number of radical polymerizable groups (the F_{N}/RP_{N}) is appropriate. As a consequence, even in the case that a larger quantity of the radical polymerizable PFPE is added, cissing of a coating film of the radical polymerizable composition is prevented from occurring, and the PFPE portion can be present homogeneously over the entire of a coating film in formation of the surface layer, even without blending of a dispersant in the radical polymerizable composition. This presumably allows the PFPE portion to be continuously present on the surface of the surface layer in a quantity sufficient for keeping the cleanability high even after the surface of the surface layer is worn away.

The radical polymerizable PFPE forms a plurality of radial polymerization linkages in the surface layer, and thus forms a high-order crosslinked structure. Accordingly, a surface layer having high strength can be obtained without lowering of the abrasion resistance, even in the case that the content of the radical polymerizable PFPE in the radical polymerizable composition is higher than that in a radical polymerizable composition using a conventional radical polymerizable PFPE.

As described above, the image bearing member is used, for example, as an electrophotographic photoconductor (organic photoconductor) for electrophotographic image forming apparatuses. For example, the image forming apparatus includes: the image bearing member; a charging device to charge the surface of the image bearing member; a light exposure apparatus to irradiate the charged surface of the image bearing member with light to form an electrostatic latent image; a developing device to feed a toner to the image bearing member on which the electrostatic latent image has been formed to form a toner image; a transfer device to transfer the toner image on the surface of the image bearing member to a recording medium; and a cleaning apparatus to remove a toner remaining on the surface of the image bearing member after transferring the toner image to the recording medium.

The image bearing member is applied to an image forming method including: feeding a toner to the surface of the image bearing member on which an electrostatic latent image has been formed to form a toner image corresponding to the electrostatic latent image on the surface of the image bearing member; transferring the toner image from the surface of the image bearing member to a recording medium; and removing the toner remaining on the surface of the image bearing member with a cleaning apparatus. The image forming method is performed, for example, by using the above image forming apparatus.

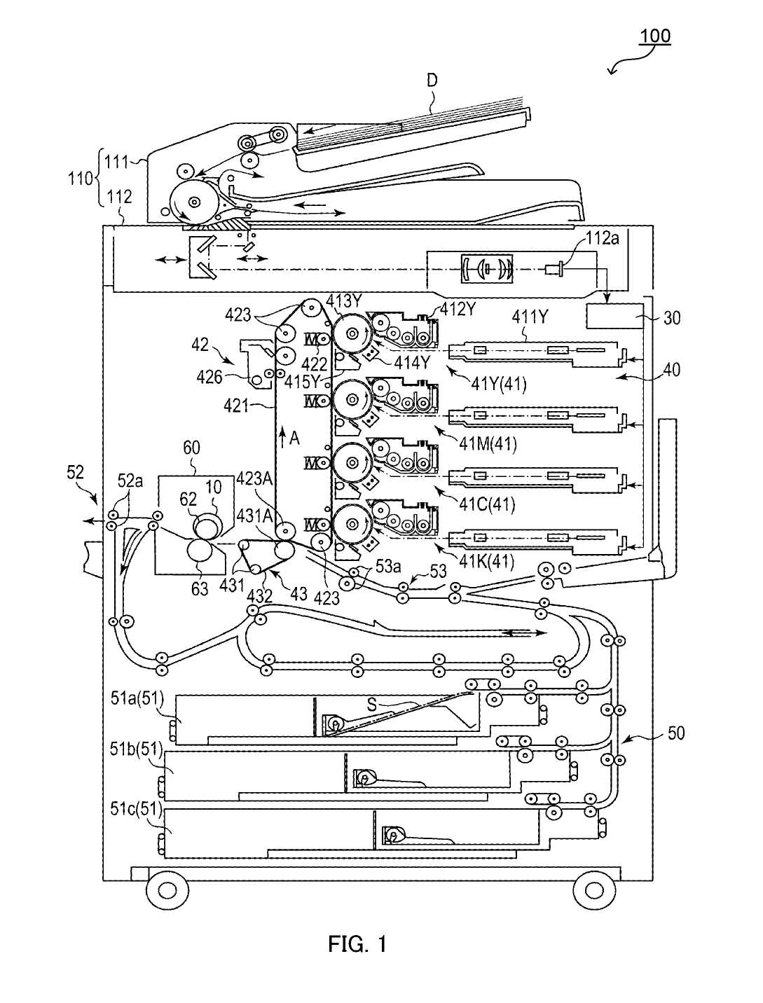

FIG. 1 is a schematic illustrating one example of configurations of an image forming apparatus including the image bearing member. Image forming apparatus 100 illustrated in FIG. 1 includes image reading section 110, image processing section 30, image forming section 40, sheet conveyance section 50, and fixing apparatus 60.

Image forming section 40 includes image forming units 41Y, 41M, 41C, and 41K to form an image with a toner of Y (yellow), M (magenta), C (cyan), or K (black). They have an identical configuration except a toner to be contained therein, and thus the signs indicating the color are occasionally omitted hereinafter. Image forming section 40 further includes intermediate transfer unit 42 and secondary transfer unit 43. Each of them corresponds to a transfer device.

Image forming unit 41 includes light exposure apparatus 411, developing device 412, image bearing member 413, which has been described in the above, charging device 414, and drum cleaning apparatus 415. Charging device 414 is, for example, a corona charger. Charging device 414 may be a contact charging device to charge image bearing member 413 by bringing a contact charging member such as a charging roller, a charging brush, and a charging blade into contact with image bearing member 413. Light exposure apparatus 411 includes, for example, a semiconductor laser as a light source and a light deflector (polygon motor) to irradiate image bearing member 413 with a laser beam in accordance with an image to be formed.

Developing device 412 is a developing device with a two-component developing system. For example, developing device 412 includes: a developing container to contain a two-component developer; a developing roller (magnetic roller) rotatably disposed at an opening of the developing container; a dividing wall to separate the inside of the developing container in such a way that the two-component developer can communicate therethrough; a conveyance roller to convey the two-component developer in the opening side of the developing container toward the developing roller; and a stirring roller to stir the two-component developer in the developing container. In the developing container, for example, a two-component developer is contained.

In the case that a lubricant is applied onto image bearing member 413, the lubricant is disposed, for example, in drum cleaning apparatus 415 or between drum cleaning apparatus 415 and charging device 414 so that the lubricant can contact the surface of the image bearing member after transfer. Alternatively, the lubricant may be fed, as an external additive for the two-component developer, to the surface of image bearing member 413 in developing.

Intermediate transfer unit 42 includes: intermediate transfer belt 421; primary transfer roller 422 to bring intermediate transfer belt 421 into pressure contact with image bearing member 413; a plurality of support rollers 423 including back-up roller 423A; and belt cleaning apparatus 426. Intermediate transfer belt 421 is laid as a loop on the plurality of support rollers 423 in a tensioned state. Intermediate transfer belt 421 runs in the direction of arrow A at a constant speed through the rotation of a drive roller of at least one of the plurality of support rollers 423.

Secondary transfer unit 43 includes: endless, secondary transfer belt 432; and a plurality of support rollers 431 including secondary transfer roller 431A. Secondary transfer belt 432 is laid as a loop on secondary transfer roller 431A and support roller 431 in a tensioned state.

For example, fixing apparatus 60 includes: fixing roller 62; endless, heating belt 10 covering the outer peripheral surface of fixing roller 62 to heat and melt a toner constituting a toner image on sheet S; and pressure roller 63 to press sheet S toward fixing roller 62 and heating belt 10. Sheet S corresponds to a recording medium.

Image forming apparatus 100 further includes image reading section 110, image processing section 30, and sheet conveyance section 50. Image reading section 110 includes sheet feeding apparatus 111 and scanner 112. Sheet conveyance section 50 includes sheet feeding section 51, sheet ejection section 52, and conveyance pathway section 53. Three sheet feed tray units 51a to 51c constituting sheet feeding section 51 contain preset, different types of sheet S (standard paper or special paper) identified on the basis of the basis weight, size, or the like. Conveyance pathway section 53 includes a plurality of pairs of conveyance rollers including pair of registration rollers 53a.

Image formation with image forming apparatus 100 will be described.

Scanner 112 optically scans and reads original image D on the contact glass. CCD sensor 112a reads a reflected light from original image D to acquire input image data. The input image data are subjected to predetermined image processing in image processing section 30, and sent to light exposure apparatus 411.

Image bearing member 413 rotates at a constant rotation speed. Charging device 414 negatively charges the surface of image bearing member 413 uniformly. In light exposure apparatus 411, the polygon mirror of the polygon motor rotates at a high speed, and laser beams each corresponding to a color component of the input image data extend along the axis direction of image bearing member 413, and applied onto the outer peripheral surface of image bearing member 413 along the axis direction. Thus, an electrostatic latent image is formed on the surface of image bearing member 413.

In developing device 412, the toner particles are charged through stirring and conveying of the two-component developer in the developing container, and the two-component developer is conveyed to the developing roller and forms a magnetic brush on the surface of the developing roller. The charged toner particles electrostatically attach from the magnetic brush to a portion corresponding to the electrostatic latent image on image bearing member 413. Thus, the electrostatic latent image on the surface of image bearing member 413 is visualized and a toner image corresponding to the electrostatic latent image is formed on the surface of image bearing member 413. Here, “toner image” refers to an image-like arrangement of toners.

The toner image on the surface of image bearing member 413 is transferred to intermediate transfer belt 421 by intermediate transfer unit 42. Untransferred residual toners remaining on the surface of image bearing member 413 after transfer are removed by drum cleaning apparatus 415 including a drum cleaning blade to be brought into sliding contact with the surface of image bearing member 413.

The surface layer of image bearing member 413 is integrally composed of a polymer formed through radical polymerization of the radical polymerizable PFPE, as described above, and PFPE portions (and metal oxide fine particles, if they are further contained) are homogeneously dispersed in a sufficient quantity over the entire of the surface layer.

Accordingly, the abrasion resistance and scratch resistance due to the sufficient hardness of the polymer and the high cleanability due to the PFPE portion can be sufficiently exerted.

Thus, image bearing member 413 is excellent in abrasion resistance, scratch resistance, and cleanability, and exerts these properties for a long period. In the case that the radical polymerizable metal oxide fine particle is further contained, mechanical strength-enhancing effect due to the metal oxide fine particle can be further obtained. In the case that image forming apparatus 100 includes a lubricant to apply onto image bearing member 413, the amount of a lubricant to be used can be reduced in comparison with the case of a conventional image forming apparatus, and the amount of use can be minimized.

Intermediate transfer belt 421 is brought into pressure contact with image bearing member 413 by primary transfer roller 422, and as a result a primary transfer nip is formed on each image bearing member. At the primary transfer nip, toner images of different colors are sequentially transferred to intermediate transfer belt 421 in an overlaying manner.

On the other hand, secondary transfer roller 431A is brought into pressure contact with back-up roller 423A via intermediate transfer belt 421 and secondary transfer belt 432. As a result, a secondary transfer nip is formed by intermediate transfer belt 421 and secondary transfer belt 432. Sheet S passes through the secondary transfer nip. Sheet S is conveyed to the secondary transfer nip by sheet conveyance section 50. Correction of inclination and adjustment of conveyance timing for sheet S are performed by a registration roller section provided with pair of registration rollers 53a.

When sheet S is conveyed to the secondary transfer nip, a transfer bias is applied to secondary transfer roller 431A. This transfer bias applied allows transfer of the toner image borne on intermediate transfer belt 421 to sheet S. Sheet S to which the toner image has been transferred is conveyed toward fixing apparatus 60 by secondary transfer belt 432.

Fixing apparatus 60 forms a fixing nip by heating belt 10 and pressure roller 63, and heats and pressurizes sheet S conveyed there at the fixing nip. As a result, the toner image is fixed on sheet S. Sheet S on which the toner image has been fixed is ejected out by sheet ejection section 52 including sheet ejection roller 52a.

Untransferred residual toners remaining on the surface of intermediate transfer belt 421 after secondary transfer are removed by belt cleaning apparatus 426 including a belt cleaning blade to be brought into sliding contact with the surface of intermediate transfer belt 421.

As described above, image bearing member 413 is excellent in abrasion resistance, scratch resistance, and cleanability, and exert these properties for a long period. Accordingly, image forming apparatus 100 can form images of intended image quality stably for a long period.

As is clear from the above description, the image bearing member for electrophotography includes the surface layer, in which the surface layer is formed of a polymerization-cured product of a radical polymerizable composition containing the radical polymerizable PFPE, and the ratio of the average number of fluorine atoms to the average number of radical polymerizable functional groups, F_{N}/RP_{N}, in the radical polymerizable PFPE is 2.0 to 20.0. Accordingly, the image bearing member is excellent in abrasion resistance, scratch resistance, and toner releasability, and is capable of preventing the occurrence of image defects due to cleaning failure for a long period in an electrophotographic image forming method.

The configuration in which the radical polymerizable composition further contains a radical polymerizable monomer is even more effective, from the viewpoint of enhancement of the abrasion resistance and scratch resistance of the image bearing member.

In addition, the configuration in which the radical polymerizable composition further contains a metal oxide fine particle having a radical polymerizable functional group is even more effective, from the viewpoint of enhancement of the abrasion resistance and scratch resistance of the image bearing member.

Further, the configuration in which the radical polymerizable PFPE has a urethane (meth)acrylate structure is even more effective, from the viewpoint of achieving cleanability and abrasion resistance in combination in the image bearing member.

Furthermore, the configuration in which the ratio of the number of fluorine atoms to the number of carbon atoms, F/C, in the surface of the surface layer is 0.30 to 1.50 is even more effective, from the viewpoint of achieving cleanability and abrasion resistance and scratch resistance in combination in the image bearing member.

The method for producing an image bearing member for electrophotography includes: forming a coating film of a coating solution for a surface layer, the coating solution containing the radical polymerizable PFPE and a solvent; and drying and curing the coating film to form the surface layer. Accordingly, the production method can provide an image bearing member being excellent in abrasion resistance, scratch resistance, and toner releasability and being capable of preventing the occurrence of image defects due to cleaning failure for a long period.

In addition, the configuration in which the production method further includes synthesizing the radical polymerizable PFPE, in which the synthesizing includes: copolymerizing a first radical polymerizable compound having a perfluoropolyether chain and a radical polymerizable functional group at each end of the perfluoropolyether chain and a second radical polymerizable compound having a first reactive functional group; and reacting the first reactive functional group of a copolymer obtained by the copolymerizing and a second reactive functional group of a third radical polymerizable compound having the second reactive functional group and a radical polymerizable functional group, the second reactive functional group being reactive with the first reactive functional group, is even more effective, from the viewpoint of adjustment of the balance between abrasion resistance and scratch resistance and toner releasability.

The present invention can provide an image bearing member for electrophotography, the image bearing member being excellent in abrasion resistance, scratch resistance, and toner releasability, and being capable of preventing the occurrence of image defects due to cleaning failure for a long period.

### EXAMPLES

[Synthesis of Radical Polymerizable PFPE 1]

The following components in the following quantities were mixed together to initiate stirring under air flow, and the temperature was raised to 80° C.

PFPE compound represented by formula (Z-1): 18 parts by weight
p-Methoxyphenol: 0.01 parts by weight
Dibutyltin laurate: 0.01 parts by weight
Methyl ethyl ketone: 20 parts by weight

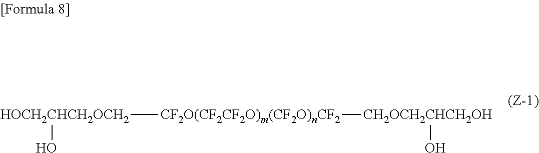

In formula (Z-1), m and n are 12 and 7, respectively, on average. The number of fluorine atoms in the PFPE compound is 66 on average. The p-Methoxyphenol is a polymerization inhibitor, and the dibutyltin laurate is a urethanization catalyst.

To the resulting mixed solution, 6.2 parts by weight of 2-(methacryloyloxy)ethyl isocyanate was then added, and the resultant was stirred for reaction at 80° C. for 10 hours. After the disappearance of the absorption peak derived from the isocyanate group around 2,360 cm⁻¹ was confirmed in IR spectrum measurement, the solvent was distilled off to afford 24.1 parts by weight of radical polymerizable PFPE 1. Radical polymerizable PFPE 1 corresponds to “PFPE-6”, which is a radical polymerizable PFPE in which X is a methacryloyl group, among those exemplified in the above.

The ratio of the average number of fluorine atoms, F_{N}, to the average number of radical polymerizable functional groups, RP_{N}, F_{N}/RP_{N}, calculated by converting the measurement results of ¹H-NMR and ¹⁹F-NMR for radical polymerizable PFPE 1 was 16.6.

[Synthesis of Radical Polymerizable PFPE 2]

The following components in the following quantities were mixed together and stirred. In formula (Z-2), m and n are 8 and 5, respectively, on average. The number of fluorine atoms in the PFPE compound below is 46 on average.

PFPE compound represented by formula (Z-2): 15 parts by weight
Pyridine: 12 parts by weight
Dimethylaminopyridine: 2.7 parts by weight
Dichloromethane: 80 parts by weight

HOCH₂—CF₂O(CF₂CF₂O)ₘ(CF₂O)ₙCF₂—CH₂OH (Z-2) [Formula 9]

To the resulting mixed solution, trifluoromethansulfonic anhydride (20.8 parts by weight) was gradually added, and the resultant was stirred at room temperature for 48 hours.

To the resulting reaction mixture, 200 parts by weight of perfluorohexane was added, and the resultant was washed with a mixed solution of dichloromethane and ethanol, and the perfluorohexane was then removed by distillation to afford 15.5 parts by weight of a PFPE intermediate represented by formula (Z-3).

[Formula 10]

CF₃SO₃CH₂—CF₂O(CF₂CF₂O)ₘ(CF₂O)ₙCF₂—CH₂OSO₂CF₃ (Z-3)

Then, 10.0 parts by weight of PFPE (Z-3) intermediate obtained and 8.0 parts by weight of diethanolamine were stirred together at 105° C. for 48 hours. To the resulting reaction mixture, 30 parts by weight of Vertrel XF (manufactured by Du Pont-Mitsui Fluorochemicals Company, Ltd., “Vertrel” is a registered trademark possessed by E. I. du Pont Nemours and Company) was added, and the resultant was washed with a mixed solution of water and methanol, and the Vertrel XF was then removed by distillation to afford 9.5 parts by weight of a PFPE intermediate represented by formula (Z-4).

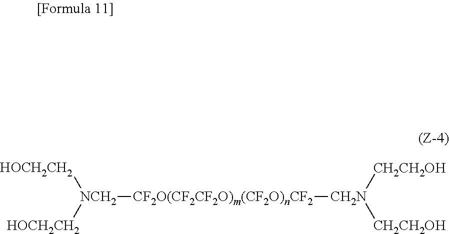

Then, the following components in the following quantities were mixed together to initiate stirring under air flow, and the temperature was raised to 80° C.

PFPE intermediate (Z-4): 8.0 parts by weight
p-Methoxyphenol: 0.01 parts by weight
Dibutyltin laurate: 0.01 parts by weight
Methyl ethyl ketone: 10 parts by weight

To the resulting mixture, 3.1 parts by weight of 2-(methacryloyloxy)ethyl isocyanate was then added, and the resultant was stirred for reaction at 80° C. for 10 hours. After the disappearance of the absorption peak derived from the isocyanate group around 2,360 cm⁻¹ was confirmed in IR spectrum measurement, the solvent was distilled off to afford 11.0 parts by weight of radical polymerizable PFPE 2. Radical polymerizable PFPE 2 corresponds to “PFPE-10”, which is a radical polymerizable PFPE in which X is a methacryloyl group, among those exemplified in the above. The F_{N}/RP_{N} of radical polymerizable PFPE 2 was 11.5.

[Synthesis of radical polymerizable PFPE 3]

The following components in the following quantities were mixed together.

PFPE compound represented by formula (Z-2): 60 parts by weight
Diisopropyl ether: 30 parts by weight
p-Methoxyphenol: 0.02 parts by weight
Triethylamine: 10 parts by weight

Then, 3.1 parts by weight of methacrylic acid chloride was dropped to the resulting mixture over 2 hours, while the mixture was stirred under air flow and the temperature of the mixture was kept at 10° C. After the completion of dropping, the resultant was stirred at 10° C. for 1 hour, and the temperature was then raised to 50° C. and stirring was performed for reaction for 10 hours.

To the resulting reaction mixture, 72 parts by weight of diisopropyl ether was then added, and thereafter the resultant was washed with water three times and dried over magnesium sulfate, and the solvent was distilled off under reduced pressure to afford 62.4 parts by weight of a PFPE intermediate represented by formula (A-1).

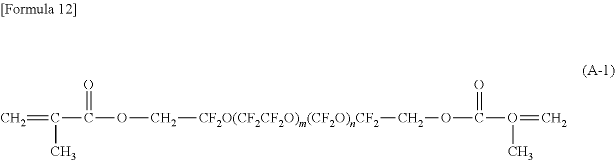

Subsequently, 80 parts by weight of methyl isobutyl ketone was placed in a flask, and the temperature was raised to 105° C. while the resultant was stirred under nitrogen flow. Separately, 60 parts by weight of PFPE intermediate (A-1), 20.0 parts by weight of 2-hydroxyethyl methacrylate, and 181 parts by weight of an initiator solution prepared by mixing 12 parts by weight of t-butylperoxy-2-ethyl hexanoate and 159 parts by weight of methyl isobutyl ketone together were each placed in one of three dropping apparatuses, and these dropping apparatuses were attached to the flask.

Then, the solutions were simultaneously dropped from the three dropping apparatuses over 2 hours while the temperature of the solution in the flask was kept at 105° C. After the completion of dropping, the resulting mixture was stirred at 105° C. for 10 hours, and the solvent was then distilled off under reduced pressure to afford 88.9 parts by weight of polymer (P-3). Subsequently, 100.0 parts by weight of methyl ethyl ketone, 0.05 parts by weight of p-methoxyphenol, and 0.04 parts by weight of tin octylate were charged into the flask to initiate stirring under air flow, and 21.1 parts by weight of 2-acryloyloxyethyl isocyanate was dropped to the resulting mixture over 1 hour while the temperature of the mixture was kept at 60° C.

After the completion of dropping, the resulting mixture was stirred at 60° C. for 1 hour, and the temperature was then raised to 80° C. and stirring was performed for reaction for 5 hours. After the disappearance of the absorption peak derived from the isocyanate group around 2,360 cm⁻¹ was confirmed in IR spectrum measurement, the solvent was distilled off to afford 110 parts by weight of radical polymerizable PFPE 3 (corresponding to the compound PFPE-X according to the present invention). The F_{N}/RP_{N} of radical polymerizable PFPE 3 was 7.1.

[Synthesis of Radical Polymerizable PFPE 4]

In a flask, 70 parts by weight of methyl isobutyl ketone was placed, and the temperature was raised to 105° C. while the methyl isobutyl ketone was stirred under nitrogen flow. Separately, 40 parts by weight of PFPE intermediate (A-1), 28.7 parts by weight of 2-hydroxyethyl methacrylate, and 147.7 parts by weight of an initiator solution prepared by mixing 10.3 parts by weight of t-butylperoxy-2-ethyl hexanoate and 137.4 parts by weight of methyl isobutyl ketone together were each placed in one of three dropping apparatuses, and these dropping apparatuses were attached to the flask.

Then, the solutions were simultaneously dropped from the three dropping apparatuses over 2 hours while the temperature of the solution in the flask was kept at 105° C. After the completion of dropping, the resulting mixture was stirred at 105° C. for 10 hours, and the solvent was then distilled off under reduced pressure to afford 71.8 parts by weight of polymer (P-2).

Subsequently, 100.0 parts by weight of methyl ethyl ketone, 0.05 parts by weight of p-methoxyphenol, and 0.04 parts by weight of tin octylate were charged into the flask to initiate stirring under air flow, and 32.6 parts by weight of 2-methacryloyloxyethyl isocyanate was dropped to the resulting mixture over 1 hour while the temperature of the mixture was kept at 60° C.

After the completion of dropping, the resulting mixture was stirred at 60° C. for 1 hour, and the temperature was then raised to 80° C. and stirring was performed for reaction for 5 hours. After the disappearance of the absorption peak derived from the isocyanate group around 2,360 cm⁻¹ was confirmed in IR spectrum measurement, the solvent was distilled off to afford 104.4 parts by weight of radical polymerizable PFPE 4 (corresponding to the compound PFPE-X according to the present invention). The F_{N}/RP_{N} of radical polymerizable PFPE 4 was 5.5.

[Synthesis of Radical Polymerizable PFPE 5]

In a flask, 60 parts by weight of methyl isobutyl ketone was placed, and the temperature was raised to 105° C. while the methyl isobutyl ketone was stirred under nitrogen flow. Separately, 19.6 parts by weight of PFPE intermediate (A-1), 37.7 parts by weight of 2-hydroxyethyl methacrylate, and 123.6 parts by weight of an initiator solution prepared by mixing 8.6 parts by weight of t-butylperoxy-2-ethyl hexanoate and 115 parts by weight of methyl isobutyl ketone were each placed in one of three dropping apparatuses, and these dropping apparatuses were attached to the flask.

Then, the solutions were simultaneously dropped from the three dropping apparatuses over 2 hours while the temperature of the solution in the flask was kept at 105° C. After the completion of dropping, the resulting mixture was stirred at 105° C. for 10 hours, and the solvent was then distilled off under reduced pressure to afford 60 parts by weight of polymer (P-1).

Subsequently, 97.3 parts by weight of methyl ethyl ketone, 0.05 parts by weight of p-methoxyphenol, and 0.04 parts by weight of tin octylate were charged into the flask to initiate stirring under air flow, and 39.7 parts by weight of 2-acryloyloxyethyl isocyanate was dropped to the resulting mixture over 1 hour while the temperature of the mixture was kept at 60° C.

After the completion of dropping, the resulting mixture was stirred at 60° C. for 1 hour, and the temperature was then raised to 80° C. and stirring was performed for reaction for 5 hours. After the disappearance of the absorption peak derived from the isocyanate group around 2,360 cm⁻¹ was confirmed in IR spectrum measurement, the solvent was distilled off to afford 99.6 parts by weight of radical polymerizable PFPE 5 (corresponding to the compound PFPE-X according to the present invention). The F_{N}/RP_{N} of radical polymerizable PFPE 5 was 2.1.

[Preparation of Metal Oxide Fine Particle 1]

In a wet sand mill (medium: alumina beads with a diameter of 0.5 mm), 100 parts by weight of a tin oxide particle having a number average primary particle size of 20 nm as a metal oxide fine particle, 7 parts by weight of “3-methacryloxypropyltrimethoxysilane (S-15)” as a surface treating agent, and 1,000 parts by weight of methyl ethyl ketone were put, and mixed together at 30° C. for 6 hours. Thereafter, the methyl ethyl ketone and alumina beads were separated from the metal oxide fine particle through filtration, and the metal oxide fine particle was dried at 60° C. Thus, metal oxide fine particle 1 was prepared as the radical polymerizable metal oxide fine particle.

[Preparation of Metal Oxide Fine Particle 2]

In a wet sand mill (alumina beads with a diameter of 0.5 mm), 100 parts by weight of a copper-aluminum oxide particle having a number average primary particle size of 50 nm as a metal oxide fine particle, 5 parts by weight of “3-methacryloxypropylmethyldimethoxysilane (S-14)” as a surface treating agent, and 1,000 parts by weight of methyl ethyl ketone were put, and mixed together at 30° C. for 6 hours. Thereafter, the alumina beads and methyl ethyl ketone were removed from the resulting mixture through filtration in the order presented, and the final filtration residue was dried at 60° C. Thus, metal oxide fine particle 2 as the radical polymerizable metal oxide fine particle was prepared.

[Preparation of Metal Oxide Fine Particle 3]

Metal oxide fine particle 3 was prepared in the same manner as preparation of metal oxide fine particle 1 except that trimethoxypropylsilane was used as a surface treating agent.

### Example 1: Production of Image Bearing Member 1

(1) Preparation of Conductive Support

The surface of a cylindrical aluminum support was cut to prepare a conductive support.

(2) Formation of Intermediate Layer

Polyamide resin (X1010, manufactured by Daicel-Degussa Ltd.): 10 parts by weight Titanium oxide particle (SMT500SAS, manufactured by TAYCA CORPORATION): 11 parts by weight
Ethanol: 200 parts by weight

The materials for an intermediate layer were mixed together, and dispersed by using a sand mill, as a disperser, in a batch mode for 10 hours to prepare a coating solution for an intermediate layer. The coating solution was applied onto the surface of the conductive support by using a dip coating method, and dried at 110° C. for 20 minutes to form an intermediate layer with a film thickness of 2 μm on the conductive support.

(3) Formation of charge generation layer

Charge generation material: 24 parts by weight
Polyvinylbutyral resin: 12 parts by weight
Mixed solution: 400 parts by weight

The materials for a charge generation layer were mixed together, and dispersed over 0.5 hours by using the circulating ultrasonic homogenizer “RUS-600TCVP” (manufactured by NIHONSEIKI KAISHA, LTD.) at 19.5 kHz and 600 W with a circulation flow rate of 40 L/hour to prepare a coating solution for a charge generation layer. The charge generation material was a mixed crystal of a 1:1 adduct of titanyl phthalocyanine and (2R,3R)-2,3-butanediol, the adduct having a clear peak at 8.3°, 24.7°, 25.1°, and 26.5° in measurement of the Cu-Kα characteristic

X-ray diffraction spectrum, and titanyl phthalocyanine with no addition. The polyvinylbutyral resin was “S-LEC BL-1” manufactured by SEKISUI CHEMICAL CO., LTD., where “S-LEC” is a registered trademark possessed by the company. The mixed solution was a mixed solvent of 3-methyl-2-butanone and cyclohexanone, and the mixing ratio was 3-methyl-2-butanone/cyclohexanone=4/1 in a volume ratio.

The coating solution was applied onto the surface of the intermediate layer by using a dip coating method, and dried to form a charge generation layer with a film thickness of 0.3 μm on the intermediate layer.

(4) Formation of Charge Transport Layer

Charge transport material represented by structural formula (2): 60 parts by weight
Polycarbonate resin: 100 parts by weight
Antioxidant: 4 parts by weight
Toluene/tetrahydrofuran: 800 parts by weight
Silicone oil: 1 part by mass

The materials for a charge transport layer were mixed and dissolved together to prepare a coating solution for a charge transport layer. The coating solution was applied onto the surface of the charge generation layer by using a dip coating method, and dried at 120° C. for 70 minutes to form a charge transport layer with a film thickness of 24 μm on the charge generation layer. The polycarbonate resin was “Z300” manufactured by MITSUBISHI GAS CHEMICAL COMPANY, INC., and the antioxidant was “IRGANOX 1010” manufactured by BASF SE. “IRGANOX” is a registered trademark possessed by the company. The toluene/tetrahydrofuran was a mixed solvent prepared by mixing 9 parts by volume of THF with 1 part by volume of toluene. The silicone oil was “KF-54” (manufactured by Shin-Etsu Chemical Co., Ltd.).

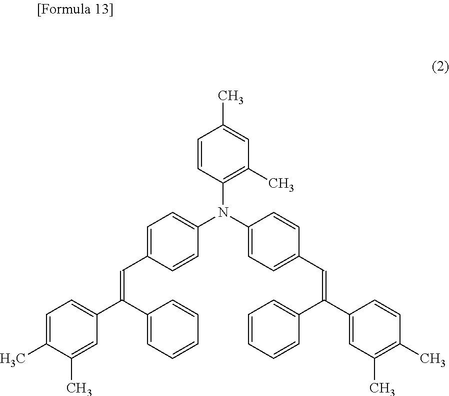

(5) Formation of Surface Layer

Radical polymerizable monomer M2: 120 parts by weight
Radical polymerizable PFPE 1: 30 parts by weight
Metal oxide fine particle 1: 150 parts by weight
Polymerization initiator 10: parts by weight

2-Butanol: 400 parts by weight

The materials for a surface layer were dissolved together and dispersed to prepare a coating solution for a surface layer. The coating solution was applied onto the surface of the charge transport layer by using a circular slide hopper coater. The polymerization initiator was IRGACURE 819 (manufactured by BASF Japan, Ltd., “IRGACURE” is a registered trademark possessed by BASF SE).

Subsequently, the film of the applied coating solution was irradiated with an ultraviolet ray from a metal halide lamp for 1 minute for curing of the film to form a surface layer with a film thickness of 3.0 μm on the charge transport layer. Thus, image bearing member 1 was produced. For determination of the ratio of the number of fluorine atoms, F, to the number of carbon atoms, C, F/C, in the surface of image bearing member 1, measurement was performed by using the X-ray photoelectron spectrometer K-Alfa (manufactured by Thermo Fisher Scientific Inc.), and the F/C was calculated from the intensities by area of carbon (Cis) and fluorine (F1s) to be 0.80.

### Examples 2 and 3: Production of Image Bearing Members 2 and 3

Image bearing member 2 was produced in the same manner as production of image bearing member 1, except that the quantity of the radical polymerizable monomer was changed to 100 parts by weight and the quantity of radical polymerizable PFPE 1 was changed to 50 parts by weight. Image bearing member 3 was produced in the same manner as production of image bearing member 1, except that the quantity of the radical polymerizable monomer was changed to 90 parts by weight and the quantity of radical polymerizable PFPE 1 was changed to 60 parts by weight. The F/C of image bearing member 2 was 1.24, and the F/C of image bearing member 3 was 1.62.

### Examples 4 to 6: Production of Image Bearing Members 4 to 6

Image bearing members 4 to 6 were produced in the same manner as production of image bearing members 1 to 3, respectively, except that radical polymerizable PFPE 2 was used in place of radical polymerizable PFPE 1. The F/C of image bearing member 4 was 0.72, the F/C of image bearing member 5 was 1.22, and the F/C of image bearing member 6 was 1.55.

### Examples 7 to 9: Production of Image Bearing Members 7 to 9

Image bearing members 7 to 9 were produced in the same manner as production of image bearing members 1 to 3, respectively, except that radical polymerizable PFPE 3 was used in place of radical polymerizable PFPE 1. The F/C of image bearing member 7 was 0.69, the F/C of image bearing member 8 was 1.01, and the F/C of image bearing member 9 was 1.42.

### Examples 10 to 12: Production of Image Bearing Members 10 to 12

Image bearing members 10 to 12 were produced in the same manner as production of image bearing members 1 to 3, respectively, except that radical polymerizable PFPE 4 was used in place of radical polymerizable PFPE 1. The F/C of image bearing member 10 was 0.40, the F/C of image bearing member 11 was 0.74, and the F/C of image bearing member 12 was 0.97.

### Examples 13 and 14: Production of Image Bearing Members 13 and 14

Image bearing members 13 and 14 were produced in the same manner as production of image bearing members 1 and 2, respectively, except that radical polymerizable PFPE 5 was used in place of radical polymerizable PFPE 1. The F/C of image bearing member 13 was 0.25, and the F/C of image bearing member 14 was 0.54.

### Example 15: Production of Image Bearing Member 15

Image bearing member 15 was produced in the same manner as production of image bearing member 1, except that radical polymerizable PFPE 5 was used in place of radical polymerizable PFPE 1, the quantity of radical polymerizable PFPE 5 was set to 150 parts by weight, and the radical polymerizable monomer was not used. The F/C of image bearing member 15 was 1.55.

### Examples 16 to 19: Production of Image Bearing Members 16 to 19

Image bearing members 16 to 19 were produced in the same manner as production of image bearing members 2, 8, 11, and 14, respectively, except that radical polymerizable monomer M6 was used in place of radical polymerizable monomer M2, and metal oxide fine particle 2 was used in place of metal oxide fine particle 1. The F/C of image bearing member 16 was 0.95, the F/C of image bearing member 17 was 0.81, the F/C of image bearing member 18 was 0.70, and the F/C of image bearing member 19 was 0.39.

### Examples 20 and 21: Production of Image Bearing Members 20 and 21

Image bearing member 20 was produced in the same manner as production of image bearing member 16, except that metal oxide fine particle 3 was used in place of metal oxide fine particle 2. Image bearing member 21 was produced in the same manner as production of image bearing member 17, except that metal oxide fine particle 3 was used in place of metal oxide fine particle 2. The F/C of image bearing member 20 was 0.80, and the F/C of image bearing member 21 was 0.78.

### Comparative Example 1: Production of Image Bearing Member C1

Image bearing member C1 was produced in the same manner as production of image bearing member 2, except that radical polymerizable PFPE 6 represented by the formula below was used in place of radical polymerizable PFPE 1. In the formula below, X denotes an acryloyl group, and m and n are 8 and 5, respectively, on average. The F_{N}/RP_{N} of radical polymerizable PFPE 6 was 23.0.

XOCH₂CH₂NHCOOCH₂—CF₂O(CF₂CF₂O)ₘ(CF₂O)ₙCF₂—CH₂OCONHCH₂CH₂OX [Formula 14]

In production of image bearing member C1, the coating material for a surface layer was applied onto the charge transport layer, and then cissing of the coating material occurred. For this reason, the F/C of image bearing member C1 could not be determined.

### Comparative Example 2: Production of Image Bearing Member C2

Image bearing member C2 was produced in the same manner as production of image bearing member C1, except that 25 parts by weight of Aron GF400 (manufactured by TOAGOSEI CO., LTD.) was further added to the coating material for a surface layer. “Aron GF400” is a fluorine-containing graft polymer. The F/C of image bearing member C2 was 1.30.

### Comparative Examples 3 and 4: Production of Image Bearing Members C3 and C4

Image bearing members C3 and C4 were produced in the same manner as production of image bearing members C1 and C2, respectively, except that radical polymerizable PFPE 7 represented by the formula below was used in place of radical polymerizable PFPE 6. In the formula below, X denotes an acryloyl group, and n is 10.1 on average. The F_{N}/RP_{N} of radical polymerizable PFPE 7 was 35.8.

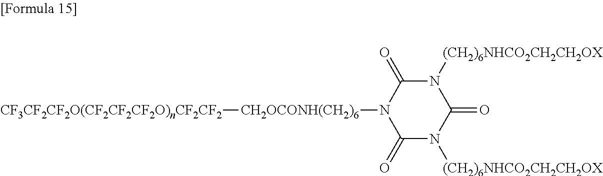

In production of image bearing member C3, the coating material for a surface layer was applied onto the charge transport layer, and then cissing of the coating material occurred. For this reason, the F/C of image bearing member C3 could not be determined. The F/C of image bearing member C4 was 1.70.

The materials and F/C of the surface layer of image bearing members 1 to 21 and C1 to C4 are listed in Table 1. In table 1, “RP-monomer” indicates “radical polymerizable monomer”, “RP-PFPE” indicates “radical polymerizable PFPE”, and “MOP” indicates “metal oxide fine particle”.

TABLE 1

| | Image | RP-momomer | | RP-PFPE | | | | |
|---|---|---|---|---|---|---|---|---|
| | bearing | | Content | | | Content | | |
| | member | | (part by | | F_{N}/RP_{N} | (part by | MOP | F/C |
| | No. | No. | mass) | No. | (—) | mass) | No. | (—) |
| Example 1 | 1 | M2 | 120 | 1 | 16.6 | 30 | 1 | 0.80 |
| Example 2 | 2 | M2 | 100 | 1 | 16.6 | 50 | 1 | 1.24 |
| Example 3 | 3 | M2 | 90 | 1 | 16.6 | 60 | 1 | 1.62 |
| Example 4 | 4 | M2 | 120 | 2 | 11.5 | 30 | 1 | 0.72 |
| Example 5 | 5 | M2 | 100 | 2 | 11.5 | 50 | 1 | 1.22 |
| Example 6 | 6 | M2 | 90 | 2 | 11.5 | 60 | 1 | 1.55 |
| Example 7 | 7 | M2 | 120 | 3 | 7.1 | 30 | 1 | 0.69 |
| Example 8 | 8 | M2 | 100 | 3 | 7.1 | 50 | 1 | 1.01 |
| Example 9 | 9 | M2 | 90 | 3 | 7.1 | 60 | 1 | 1.42 |
| Example 10 | 10 | M2 | 120 | 4 | 5.5 | 30 | 1 | 0.40 |
| Example 11 | 11 | M2 | 100 | 4 | 5.5 | 50 | 1 | 0.74 |
| Example 12 | 12 | M2 | 90 | 4 | 5.5 | 60 | 1 | 0.97 |
| Example 13 | 13 | M2 | 120 | 5 | 2.1 | 30 | 1 | 0.25 |
| Example 14 | 14 | M2 | 100 | 5 | 2.1 | 50 | 1 | 0.54 |
| Example 15 | 15 | — | 0 | 5 | 2.1 | 150 | 1 | 1.55 |
| Example 16 | 16 | M6 | 100 | 1 | 16.6 | 50 | 2 | 0.95 |
| Example 17 | 17 | M6 | 100 | 3 | 7.1 | 50 | 2 | 0.81 |
| Example 18 | 18 | M6 | 100 | 4 | 5.5 | 50 | 2 | 0.70 |
| Example 19 | 19 | M6 | 100 | 5 | 2.1 | 50 | 2 | 0.39 |
| Example 20 | 20 | M2 | 100 | 1 | 16.6 | 50 | 3 | 0.80 |
| Example 21 | 21 | M6 | 100 | 3 | 7.1 | 50 | 3 | 0.78 |
| Comparative | C1 | M2 | 100 | 6 | 23.0 | 50 | 1 | — |
| Example 1 | | | | | | | | |
| Comparative | C2 | M2 | 100 | 6 | 23.0 | 50 | 1 | 1.30 |
| Example 2 | | | | | | | | |
| Comparative | C3 | M2 | 100 | 7 | 35.8 | 50 | 1 | — |
| Example 3 | | | | | | | | |
| Comparative | C4 | M2 | 100 | 7 | 35.8 | 50 | 1 | 1.70 |
| Example 4 | | | | | | | | |

[Evaluation]

Each of image bearing members 1 to 21 and C2 and C4 was installed in a full-color copier (product name: bizhub PRO C6501, manufactured by KONICA MINOLTA, INC., “bizhub” is a registered trademark possessed by the company), and a durability test was carried out in which 500,000 sheets of a character image with an image ratio of 6% were continuously printed out in the A4 crosswise direction in an high temperature and high humidity environment (HH environment) of 30° C. and 85% RH, without application of a lubricant onto an image bearing member. As described above, cissing of the coating material occurred and a surface layer of intended characteristics was not formed for image bearing members C1 and C3, and thus image bearing members C1 and C3 were not used for the durability test.

(1) Abrasion Resistance

Before and after the durability test, 10 portions of homogeneous film thickness (portions within at least 3 cm from each edge were excluded, because the film thickness of each edge of an image bearing member is likely to be heterogeneous) in each image bearing member were randomly selected to measure the thickness by using an eddy current-type film thickness gauge (product name: “EDDY560C”, manufactured by HELMUT FISCHER GMBTE, CO.), and the average value was calculated and used as the thickness of the layer on an image bearing member. The difference between the thicknesses of the layer before and after the durability test was used as an amount of abrasion. A smaller amount of abrasion indicates higher abrasion resistance, and an amount of abrasion of 2.5 μm or smaller is sufficient for practical use.

(2) Scratch Resistance

After the durability test, a halftone image was output on the whole surface of an A3 sheet, and the scratch resistance of each image bearing member was evaluated on the basis of the following criteria.

A: No prominent scratch was found in the surface of an electrophotographic photoconductor by visual observation, and in addition image failure corresponding to a scratch of the photoconductor was not found in the halftone image (good).

B: Although generation of a minor scratch was found in the surface of an electrophotographic photoconductor by visual observation, image failure corresponding to the scratch of the photoconductor was not found in the halftone image (sufficient for practical use).

C: Generation of a scratch was clearly found in the surface of an electrophotographic photoconductor by visual observation, and in addition the occurrence of image failure corresponding to the scratch was found in the halftone image (insufficient for practical use).

(3) Cleanability

During and after the durability test, the surface of each image bearing member was visually observed, and the cleanability of the image bearing member was evaluated on the basis of the following criteria.

A: Toner slipping did not occur until the 500,000th sheet was printed out, and thus a cleanability satisfactory for practical use was achieved.

B: Although toner slipping onto a photoconductor was found to a certain degree before the 500,000th sheet was printed out, the output images were good, and thus a cleanability sufficient for practical use was achieved.

C: Although minor, streak-like image failure due to toner slipping occurred in an output image before the 500,000th sheet was printed out, the cleanability could be deemed sufficient for practical use.

D: The occurrence of clear, streak-like image failure due to toner slipping was found in an output image before the 500,000th sheet was printed out (insufficient for practical use).

The evaluation results for the image bearing members are shown in Table 2.

TABLE 2

| | Image bearing | Amount of | Scratch | |
|---|---|---|---|---|
| | member No. | abrasion (μm) | resistance | Cleanability |
| Example 1 | 1 | 0.9 | A | A |
| Example 2 | 2 | 1.3 | A | A |
| Example 3 | 3 | 2.3 | B | A |
| Example 4 | 4 | 0.8 | A | A |
| Example 5 | 5 | 1.2 | A | A |
| Example 6 | 6 | 1.8 | B | A |
| Example 7 | 7 | 0.8 | A | B |
| Example 8 | 8 | 1.1 | A | A |
| Example 9 | 9 | 1.5 | A | A |
| Example 10 | 10 | 0.7 | A | B |
| Example 11 | 11 | 0.9 | A | A |
| Example 12 | 12 | 1.3 | A | A |
| Example 13 | 13 | 0.6 | A | C |
| Example 14 | 14 | 0.7 | A | B |
| Example 15 | 15 | 1.8 | B | A |
| Example 16 | 16 | 0.6 | A | A |
| Example 17 | 17 | 1.2 | A | A |
| Example 18 | 18 | 0.8 | A | B |
| Example 19 | 19 | 0.5 | A | B |
| Example 20 | 20 | 1.6 | B | A |
| Example 21 | 21 | 1.8 | B | A |
| Comparative | C1 | — | — | — |
| Example 1 | | | | |
| Comparative | C2 | 2.9 | C | A |
| Example 2 | | | | |
| Comparative | C3 | — | — | — |
| Example 3 | | | | |
| Comparative | C4 | 4.2 | C | B |
| Example 4 | | | | |

As shown in Table 2, each of image bearing members 1 to 21 has a sufficiently small amount of abrasion after the durability test, and has sufficient scratch resistance and cleanability.

As is clear from comparison of image bearing member 15 with image bearing members 13 and 14, for example, the configuration in which the coating solution for a surface layer further contains a radical polymerizable monomer is preferred, from the viewpoint of reduction of the abrasion of an image bearing member to enhance the scratch resistance.

As is clear from comparison of image bearing members 16 and 17 with image bearing members 2 and 8 or image bearing members 16 and 17, for example, the configuration in which the metal oxide fine particle in the coating solution for a surface layer has a radical polymerizable functional group on its surface is even more effective, from the viewpoint of reduction of the abrasion of an image bearing member to enhance the scratch resistance.

As is clear from comparison among image bearing members 13 to 15, for example, the configuration in which the F/C is 0.3 to 1.5 is even more effective from the viewpoint of achieving cleanability and mechanical strength in combination.

In contrast, each of image bearing members C1 to C3 could not have a surface layer of intended characteristics. This is presumably because the number of fluorine atoms relative to the number of radical polymerizable functional groups in the radical polymerizable PFPE was excessively large, which excessively increased the liquid repellency of the coating solution for a surface layer against the surface to be coated, and as a result cissing of the coating material occurred.

Each of image bearing members C2 and C4 was insufficient in abrasion resistance and scratch resistance. This is presumably because, in a situation that the number of fluorine atoms relative to the number of radical polymerizable functional groups in the radical polymerizable PFPE was excessively large, combined use of a dispersant could prevent the occurrence of the cissing, but the crosslinked structure formed through radical polymerization was insufficient, and as a result the mechanical strength of the surface layer was insufficient.

From the above description, the configuration in which the surface layer of an image bearing member for electrophotography is formed of a polymerization-cured product of a radical polymerizable composition containing a radical polymerizable PFPE, and the F_{N}/RP_{N} of the radical polymerizable PFPE is 2.0 to 20.0 makes the image bearing member sufficient in all of abrasion resistance, scratch resistance, and cleanability.

### INDUSTRIAL APPLICABILITY

The present invention can enhance the abrasion resistance, scratch resistance, and cleanability of an electrophotographic image bearing member for electrophotographic image forming apparatuses. Accordingly, the present invention is expected to provide electrophotographic image forming apparatuses with higher performance and higher durability, and to make them more common.

What is claimed is:

1. An image bearing member for electrophotography, the image bearing member comprising a surface layer, wherein
the surface layer comprises a polymerization-cured product of a radical polymerizable composition containing a perfluoropolyether compound having two or more radical polymerizable functional groups, and
a ratio of the average number of fluorine atoms to the average number of radical polymerizable functional groups in the perfluoropolyether compound having radical polymerizable functional groups is 2.0 to 20.0.

2. The image bearing member according to claim 1, wherein the radical polymerizable composition further contains a radical polymerizable monomer.

3. The image bearing member according to claim 2, wherein the radical polymerizable composition further contains a metal oxide fine particle having a radical polymerizable functional group.

4. The image bearing member according to claim 1, wherein the perfluoropolyether compound having radical polymerizable functional groups has a urethane (meth)acrylate structure.

5. The image bearing member according to claim 1, wherein the ratio of the number of fluorine atoms to the number of carbon atoms in a surface of the surface layer is 0.30 to 1.50.

6. A method for producing an image bearing member for electrophotography, the method comprising:
forming a coating film of a coating solution for a surface layer, the coating solution containing a perfluoropolyether compound having two or more radical polymerizable functional groups and a solvent; and
drying and curing the coating film to form a surface layer, wherein
a ratio of the average number of fluorine atoms to the average number of radical polymerizable functional groups in the perfluoropolyether compound having radical polymerizable functional groups is 2.0 to 20.0.

7. The method for producing an image bearing member according to claim 6, further comprising synthesizing the perfluoropolyether compound having radical polymerizable functional groups, wherein the synthesizing includes:
copolymerizing a first radical polymerizable compound having a perfluoropolyether chain and a radical polymerizable functional group at each end of the perfluoropolyether chain and a second radical polymerizable compound having a first reactive functional group; and
reacting the first reactive functional group of a copolymer obtained by the copolymerizing and a second reactive functional group of a third radical polymerizable compound having the second reactive functional group and a radical polymerizable functional group, the second reactive functional group being reactive with the first reactive functional group.
